(19) United States
(12) Patent Application Publication
(10) Pub. No.: US 2007/0176439 A1
(43) Pub. Date: Aug. 2, 2007

(54) Multi-purpose bumper guards

(76) Inventor: Jack Meltzer, Dumont, NJ (US)

Correspondence Address: Arthur M. Peslak, Esq.;Mandel & Peslak, LLC, Suite 5, 80 Scenic Drive, Freehold, NJ, 07728-5211, US

(21) Appl. No.: 11/652,329

(22) Filed: Jan. 11, 2007

Related U.S. Application Data
(63) Continuation-in-part of application No. 10/897,511, filed on Jul. 21, 2004, now Pat. No. 7,163,244.

(51) Int. Cl. B60R 19/56

(52) U.S. Cl. 293/102

(57) ABSTRACT

What is disclosed is a device directed to protecting surfaces from damage due to low-impact forces. The device is fabricated from resilient plastic material that will absorb such forces and return to its original shape without breaking or permanent deformation. The device disclosed is semi-circular in cross-section and is adhered to the surface to be protected by means of double-sided adhesive tape or, alternatively, by means of a bracket.

### PRIORITY

### BACKGROUND OF THE INVENTION

The present invention is directed to a multi-purpose device for protecting surfaces from slow speed collisions. The present invention can be applied to an automobile bumper to protect the automobile from damage in slow speed accidents. The device can also be adapted for use on automobile side doors to protect the doors from dents in a parking lot when doors are opened or closed. However, the present invention should not be limited to automobile applications only. Rather, the present invention can be readily adapted to other surfaces that need protection including, but not limited to, loading docks at warehouses for trucks or boat docks. In addition, it is also presently contemplated that the device can be applied to the front of a motorcycle wheel guard. Thus, the present invention can be utilized to replace any present impact area with a flexible, built-in impact protection.

### SUMMARY OF THE INVENTION

The present invention is directed to a device to be adhered to an automobile bumper, automobile side door, or other surface requiring protection from slow-speed collisions. The device comprises a resilient compressible material of length, a width and a semi-circular cross-section. The device further comprises an adhesive or other means adapted for attaching the device to the surface to be protected. In one embodiment, double-backed adhesive tape is utilized while a bracket is utilized in an alternative embodiment to attach the device to the surface to be protected.

### BRIEF DESCRIPTION OF THE DRAWINGS

FIGS. 1a, 1b and 1c are plan views of three embodiments the device of the present invention.

FIGS. 2a, 2b and 2c are cross-section views of the three devices shown in FIGS. 1 a, b and c respectively.

FIG. 3 is a plan view of a device of the present invention as applied to the side door of an automobile.

FIG. 4 is a plan view of a device of the present invention as applied to an automobile bumper.

FIGS. 5a, 5b and 5c illustrate the device of the present invention just prior to, during and just after a collision.

FIG. 6 is a plan view of an alternate embodiment of the present invention.

FIG. 7 illustrates the mounting of the embodiment shown in FIG. 6.

FIG. 8 illustrates a side sectional view of the embodiment illustrated in FIGS. 6 and 7.

FIG. 9 illustrates a side sectional view of an alternate embodiment illustrated in FIGS. 6 and 7.

### DETAILED DESCRIPTION OF THE INVENTION

The present invention will now be described in terms of the presently preferred embodiment as illustrated in the drawings. However, those of ordinary skill in the art will recognize that many obvious modifications may be made thereto without departing from the spirit or scope of the invention as set forth in the appended claims.

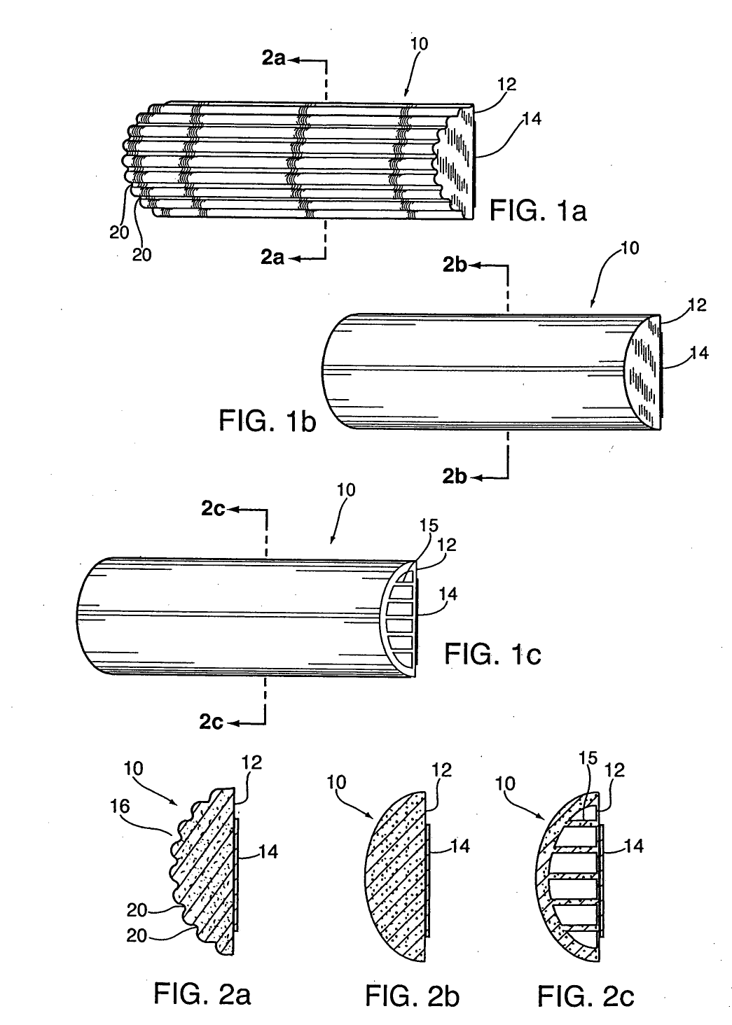

The bumper guard 10 of the present invention is illustrated in FIG. 1 and FIG. 2. The bumper guard 10 is semi-circular in cross-section. The bumper guard can be a variety of different lengths “L” depending upon the application.

For example, when applied to an automobile bumper with a straight surface, it is presently contemplated that the length will be approximately seven inches. When applied on a side door of the automobile or to a curved portion of the bumper, the length may only be about one inch. The flat surface 12 of the bumper guard 10 will be provided with double-sided adhesive tape with covering tape 14. The double-sided adhesive tape 14 will first be adhered to the flat surface 12 during manufacture and the covering tape 14 will be removed from the double backed tape to expose the adhesive and then the bumper guard 10 will be adhered to a surface, such as a bumper 19 or side door 18, to be protected by the bumper guard 10. The semi-circular surface 16 of the bumper guard 10 will then protrude from the surface 18 or 19 to be protected. Thereby, the surface 18 or 19 will be protected from slow speed impacts.

The semi-circular surface 16 of the bumper guard 10 shown in FIGS. 1a and 2a comprises a plurality of longitudinal recesses 20. The longitudinal recesses 20 allow the bumper guard 16 to absorb a higher impact force than a merely smooth surface. The bumper guard 10 in FIGS. 1b and 2b comprises a smooth outer surface. The bumper guard 10 illustrated in FIGS. 1c and 2c is partially hollow with a plurality of internal spines 15.

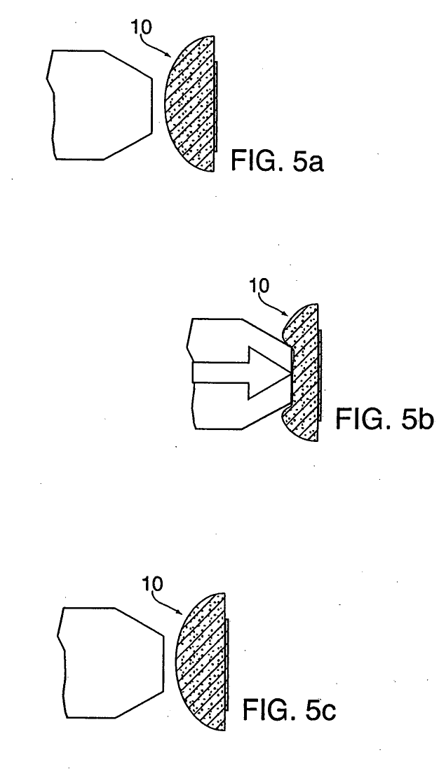

The bumper guard 10 can be fabricated from resilient flexible plastic material that absorbs the force of a slow speed impact by compressing upon impact and then returning to its original semi-circular shape without breaking or cracking as illustrated in FIGS. 5a, 5b and 5c. It is presently contemplated that the bumper guard 10 will be fabricated from resilient polyethylene, which does not contain any plasticizers. This type of material is resilient and flexible but will not dry up when exposed to the elements and become brittle. If the material were to become brittle when exposed to the elements, then the purpose of the present invention would be defeated by such a material. However, it is also contemplated that other materials with the same or similar characteristics as polyethylene without plasticizers can be substituted without departing from the spirit or scope of the present invention.

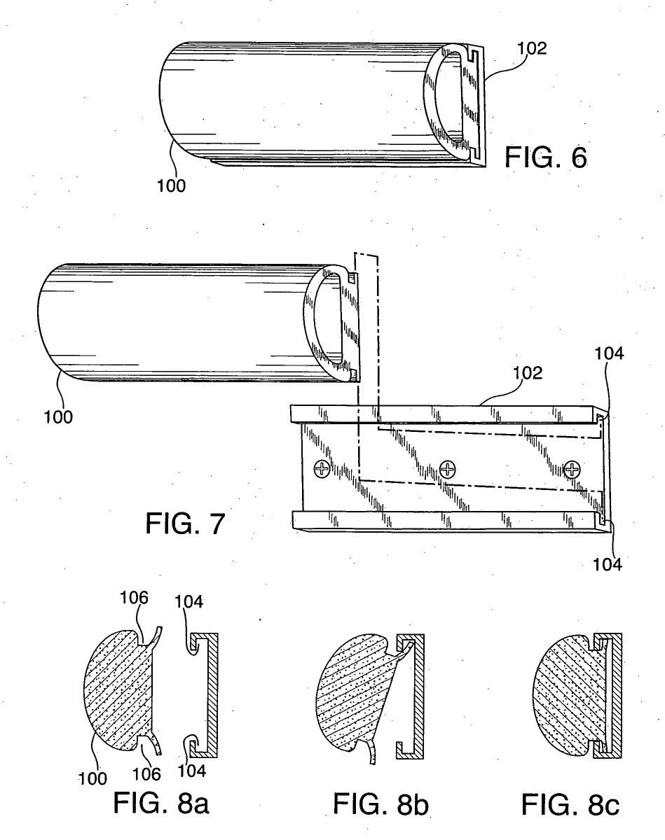

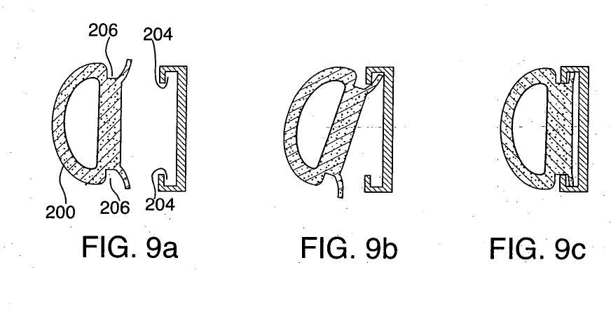

An alternate embodiment of the present invention is illustrated is FIGS. 6, 7 and 8. In that embodiment, the guard 100 is mounted in a bracket 102. The bracket 102 comprises longitudinal slots 104 for securing and holding the guard 100 in the bracket. The guard 100 in this embodiment is semi-circular in cross-section and comprises longitudinal slots 106 which are adapted to receive the bracket 102 by means of slots 104. The installation of guard 100 on bracket 102 is illustrated in FIG. 8. The guard 100 can slide into the bracket as shown in FIG. 7. As shown in FIGS. 8a, 8b and 8c, the properties of the material that make the bumper guard 100 useful to absorb impact can also be utilized for installing the guard 100 into the bracket 102. Since the material of the guard 100 is flexible, it can be deformed by pressure to a certain extent. This flexibility allows it to be easily squeezed into the bracket 102 and then it returns to its original shape after the pressure is relieved and the bumper guard is thereby tied into the bracket 102. Although FIGS. 8a, 8b and 8c illustrate the guard 100 with a solid interior, it is anticipated that the same means of attachment can be used for the guard with the hollow interior illustrated in FIGS. 9a, 9b and 9c. In addition to a hollow or solid interior, the guard 100 can be provided with one or more internal spines to provide impact resistance. Such spines are illustrated in FIG. 2c but can be readily adapted to this embodiment.

The bracket 102 is adapted to be secured to the surface to be protected by means of screws or other known fasteners. This embodiment is particularly appropriate for use on loading docks and in boat marinas. This type of installation allows for easy replacement of the guard 100 if necessary. In this embodiment, the guard is fabricated from polyethylene without plasticizer as in the previous embodiment. The presence of the plastic material absorbs the vibrations caused on impact. Although this embodiment illustrates an application for use as a bumper guard to protect a surface, the concept of deforming material to reasonably attach the device to another can be applied in a variety of circumstances as set forth herein.

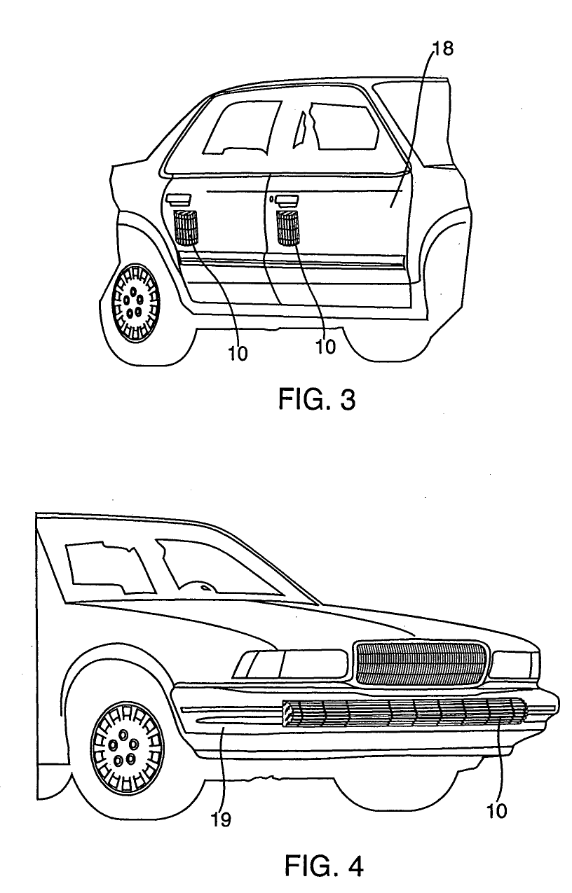

As noted above, the length L of the bumper guard 10 can be varied for adaptation to the particular application. For example, a typical length for application to a straight automobile bumper would be about seven inches. Such an application is illustrated in FIG. 1. A typical length for application to the side door of an automobile would be about one inch. Such an application is illustrated in FIG. 3. If the outer wall width is increased, the amount of resistance to an impact force of the bumper guard is increased. Likewise, decreasing the outer wall width decreases the amount of resistance to an impact force. In addition, the embodiment shown in FIG. 2C, the resistance may also be varied by varying the thickness of the part labeled 15. Thus, by varying the length L and width W of the bumper guard 10, the number of distinct potential applications for the present invention is extremely large. It is contemplated that these variations are all obvious modifications to the present invention and fall within its contemplated scope.

Those of ordinary skill in the art will recognize the foregoing description merely illustrates an embodiment of the present invention and many modifications may be made thereto without departing from the spirit or scope of the present invention as set forth in the appended claims.

What is claimed is:

1. A multi-purpose impact absorbent device for protecting a surface from a slow speed collision comprising a resilient compressible material of a length, a width and a cross-section with a top surface and a flat bottom surface adapted for installation on a bracket on the surface wherein the device will protect the surface by deforming from a force created by a slow speed collision and then return to its original shape upon removal of the force.

2. The device of claim 1 wherein the resilient properties of the material of the device allow the device to be deformed by application of a force for installation into the bracket and then return to its original shape when the force is released.

3. The device of claim 1 wherein the cross-section of the device comprises a hollow interior.

4. The device of claim 1 wherein the cross-section of the device comprises a partially hollow interior with one spine adapted to provide impact resistance.

5. The device of claim 1 wherein the cross-section of the device comprises a partially hollow interior with a plurality of spines adapted to provide additional impact resistance.

6. The device of claim 1 wherein the top surface of the device further comprises a plurality of longitudinal recesses.

7. The device of claim 1 wherein double-sided adhesive tape is provided on the flat, bottom surface to provide further attachment of the device to the surface to be protected.
